(19) United States
(12) Patent Application Publication
(10) Pub. No.: US 2015/0148948 A1
(43) Pub. Date: May 28, 2015

(54) MIXING MACHINE MOTION IN A HANDHELD MARKING DEVICE

(71) Applicants: Dilip Singh, Montreal (CA); Michael Isner, Santa Monica, CA (US)

(72) Inventors: Dilip Singh, Montreal (CA); Michael Isner, Santa Monica, CA (US)

(21) Appl. No.: 14/088,371

(22) Filed: Nov. 23, 2013

(51) Int. Cl. B25J 11/00; G05B 15/02

(52) U.S. Cl. CPC B25J 11/005; G05B 15/02; Y10S 901/02; Y10S 901/30
USPC 700/245; 700/275; 901/2; 901/30

(57) ABSTRACT

Current handheld marking devices typically use hand movement to create marks on a surface. Marks, in this context, can be defined as an area on a surface having different physical properties from its surroundings. Such marks are created by the motion of a marking region that travels on a surface plane, creating a mark over time. Examples of such devices are: pens, brushes, markers, spray tools, and engraving instruments.

Marking devices carry motion from the brain, to the hand, through the device and onto the surface. A feedback loop is created from the brain to hands to a final mark on a surface. The mark is observed as it is created and loops back into the brain. This creative mark making loop is the process to generate a visual element or design on a surface.

Typically this loop is consistent across handheld marking devices.

### SUMMARY

A new type of marking loop can be created through the addition of a motion generated by a machine that uses algorithms to control its path through space. The present invention, in one broad form would combine the motion of a hand holding the device and the motion of such a machine.

Since machine motion can be computer controlled, all aspects of the loop from the brain to the physical mark can be interwoven with these new dimensions of action and reaction.

A simple example would be the hand driving macro large scale motion and a machine driving small scale micro machine motion. The hand could move in a simple arc, the machine motion could draw thousands of tiny circles. The resulting mark would be thousands of small circles flowing in a simple arc.

A more sophisticated example would involve the reaction of the machine motion to the motion of the hand. As the hand accelerated quickly the machine motion could vibrate in a sine wave. As the hand slowed down it could dampen the machine motion and reveal exactly the motion of the hand. This would create a new type of marking loop where high velocity motion looks very different from slow strokes and puts the brain in the mindset of a new creative space, and a new kind of marking loop.

The machine marking loop could have as its source input a variety of digital inputs. A simple example would be reaction to music and sound. The machine marking loop would shift into different motion patterns based on music. A more sophisticated loop could connect directly to the brain, the internet or an external form of digital communication such as a phone or tablet device where the external device functions as a digital path generator. In such a scenario the user could customize the machine motion to feed the marking device patterns to draw.

Overall the integration of machine motion into mark making profoundly changes the character of the marks being created, and the feedback loop that occurs while making marks.

The present invention, in one broad form, provides a robot arm as the motion generating machine. The robot arm sits at the end of a hand held device and moves the marking head. Such a robot arm could take many forms and variants, ranging from two-dimensional robotic components, articulated robots, SCARA robots, Delta robots and Cartesian coordinate robots.

In this embodiment, the device is moved by the hand in a similar manner to a marker. The robot arm moves with the device and interweaves additional motion generated through digital inputs. The computer control system drives a wide variety of changes to both the mark and the marking loop.

### BACKGROUND ART

In the past, inventors have proposed adding electronics to a drawing device such as a pen. One category of such inventions is where electronics are added but do not affect the marking process. An example would be: U.S. Pat. No. 7,239,306

Another category of marking device patents use the pen as a computer input device. The pen is not leaving a mark on the surface and is acting more like a virtual input. An example of such a patent is: U.S. Pat. No. 4,878,553

Another category of marking device patents uses the pen as a recording device. The pen makes marks, but in a conventional marking loop and later moves the recording onto a computer such as: U.S. Pat. No. 5,434,371

A final category of background art is patents that put an ink-jet printer on the head of a pen. An example of such a patent: U.S. Pat. No. 4,746,936. Such patents describe a device that doesn't combine machine motion; they only use ink-jet technology to add minor flourishes to the marks being put on a page.

The present invention described in this patent is focused on extending the marking loop by combining machine motion.

### BRIEF DESCRIPTION OF THE DRAWINGS

FIGS. 1A-1B show a diagram of a marking loop and a marking loop with machine motion

FIG. 2 shows a perspective view of handheld marking device that mixes machine motion according to an embodiment of the invention.

FIG. 3 shows the marking device from FIG. 2 with the outer casing removed

FIG. 4 shows the motor connection to the robot arm for the marking device from FIG. 2

FIG. 5 is a flowchart describing how machine motion could be blended into a handheld marking device.

FIGS. 6A-6C shows the robot arm from FIG. 2 creating a mark by moving along a surface.

FIGS. 7A-7C shows the robot arm from FIG. 2 moving perpendicular to the marking surface.

FIGS. 8A-8C shows the robot arm from FIG. 2 in a range of tilted configurations

FIG. 9 shows an embodiment of how a single arm from FIG. 2 could be constructed with magnetic connections.

FIG. 10 is a flow chart describing a process for taking input and creating a desired machine motion.

FIG. 11 shows a diagram of the marking loop with machine motion and sensor feedbac

### DETAILED DESCRIPTION

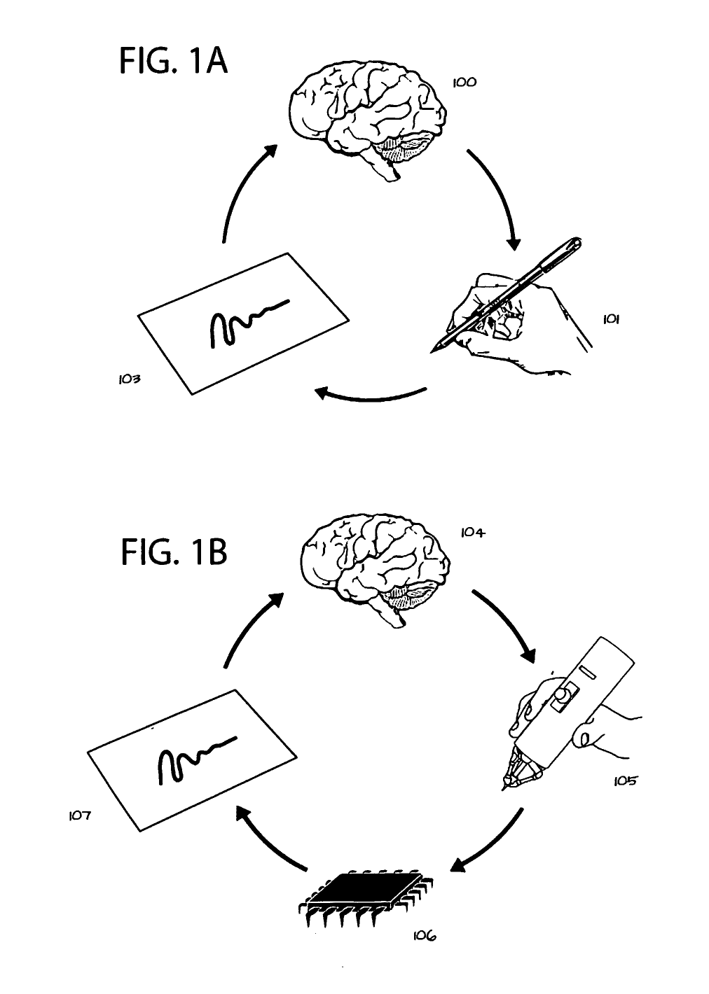

FIG. 1A shows a conventional marking loop when the brain 100 moves the hand 101 which creates the mark 103. The brain observes the mark and the feedback loop cycles forward.

FIG. 1B shows the marking loop with the addition of machine motion. The brain 104 moves the hand 105, which is in this case, is holding an embodiment of the invention with a handheld robot arm. An electronic control system 106, in this case a chip drives the motion of motors and results in machine motion. The combined motion of the hand and machine creates the mark 107. The brain observes the mark and the feedback loop cycles forward.

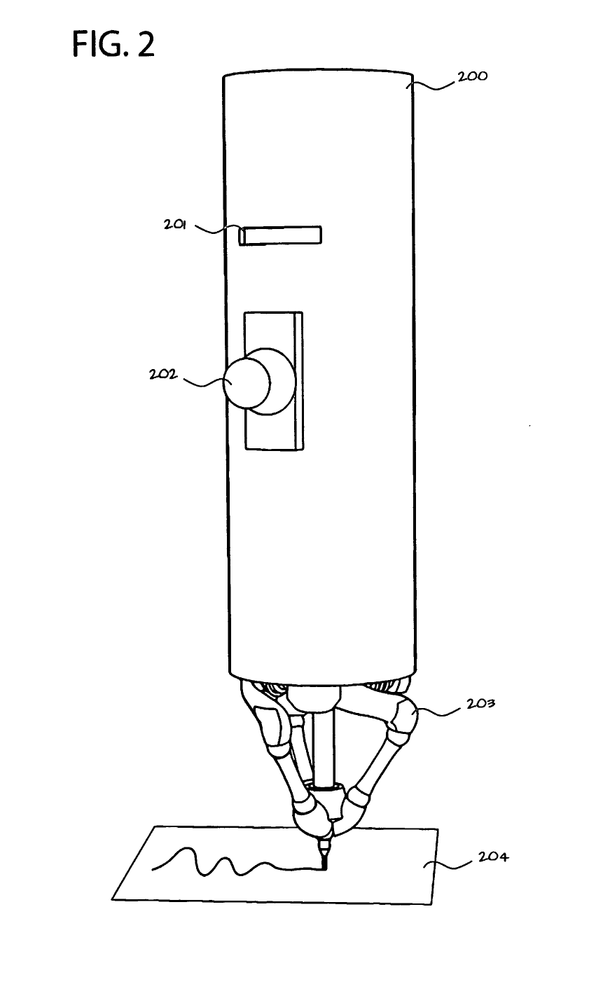

FIG. 2 shows a handheld marking device that mixes machine motion according to an embodiment of the invention. The outer body of the device 200 in this embodiment is a tubular form that a hand can grip and move. In this embodiment, a robot arm 203 is located within the bottom section of the device. This embodiment of the robot arm consists of three sub-arms connected together at an end effector. The end effector is a connection that holds the marking region against the surface 204 and draws a mark. This end effector contains a nozzle that holds a marking object which generates the mark on the surface. Motion in the robot arm 203 could add a layer of machine motion on top of the handheld motion created by the motion of a hand gripping and moving the casing 200. The marking region, in this embodiment, follows the combined motion of the hand and the machine motion. The marking region changes the physical properties of the surface by: depositing pigment (i.e., ink, lead, etc.) through surface friction, spraying, stamping, engraving, and many other marking forms. Once the mark is complete, the area of the mark on the surface is physically different than its surrounding areas.

A LED light 201 communicates state feedback of the robot arm and machine motion tasks. For example, a single flash of light could signal to the user that a task like drawing a circle has been completed. The user can then decide to move their hand to a new drawing location. In addition, a joystick controller or slider 202 allows the user of the device to manipulate configurations and provides a further level of micro control over how the user interacts with the marking loop and machine motion mixing. For example, the joystick could be used to control mathematical transformations such as scale of the marking path or pattern. Alternatively, the joystick on the device could be used to cycle through stored mark making paths or patterns. In this embodiment, a computer controller sits within the casing and manages the transformation of the device from various forms of input into machine motion.

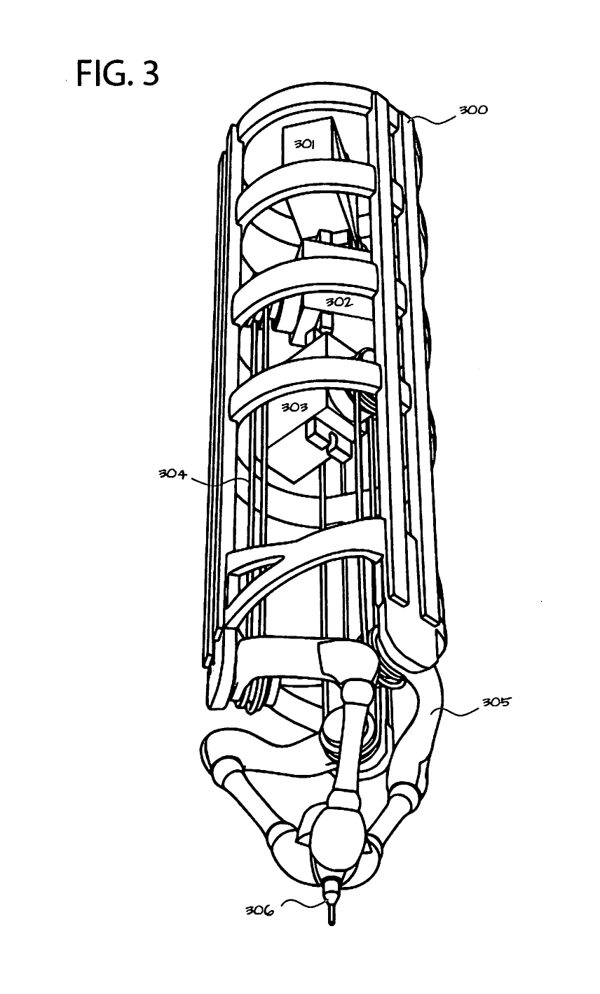

FIG. 3 shows the marking device from FIG. 2 with the casing removed. A plastic frame 300 could hold together the components of the device shown in this embodiment. Such components could include a mechanism driving the machine motion: a computer controller and motors 301, 302 & 304. The motion from the motors could transfer power to the robot arm 305 through various mechanisms. One such mechanism in this embodiment could be a simple pulley system with braided fishing line 304. Other embodiments could be a belt pulley or a gear belt pulley.

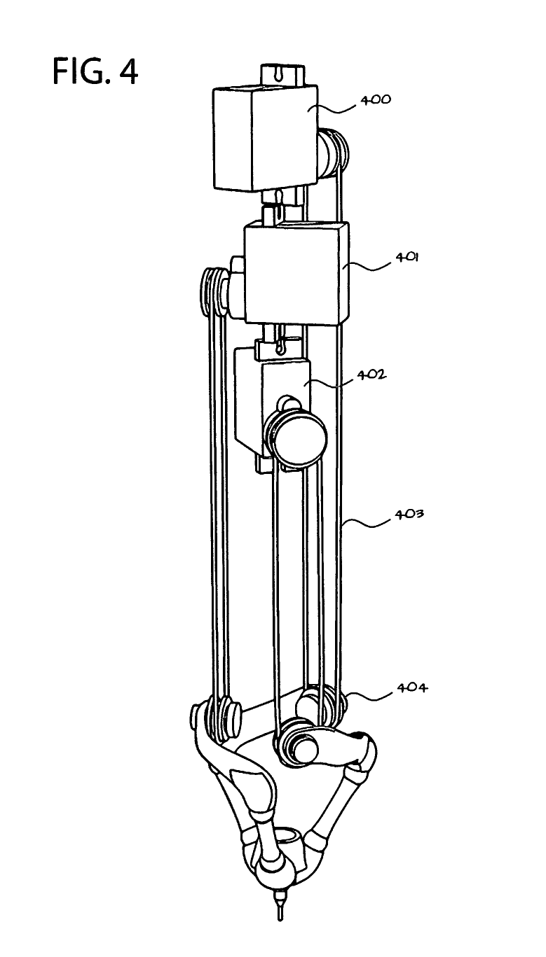

FIG. 4 shows an example connection of the motors and robot arm for the marking device from FIG. 2. The motors shown in 400, 401 & 402 show an example of the transfer of power by a pulley system 403 to the robot arm 404 without casing or frame.

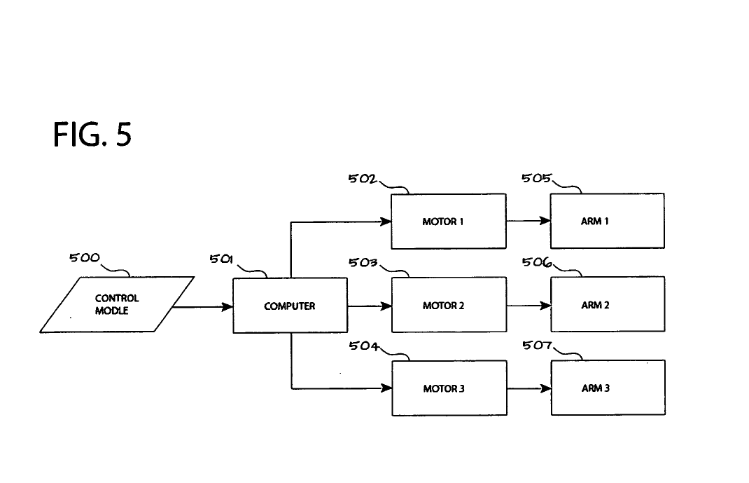

The electronic control of the arms and motors in this embodiment is shown in FIG. 5. A control module 500 which in one example could be a piece of software drives an embedded computer 501. The software could take user, environment, network and electronic input and use it to determine the position of the robot arm 404 at a given moment in time. Electronic input could take many forms. For example, input configurations can include: wireless, mobile, tablet, computer, or internet. The input information transmitted to the device, in this embodiment, is a language of commands that allows for programmatic control of all aspects and dimensions of the machine motion. These aspects include position, tilt, velocity, motion path, dynamics, kinematics, and adaptive behavior of the marking region in relation to the surface and user input. The computer 500 would then send instructions to the servo motors 502,503 & 504 which would then transfer power to the sub-arms 505,506 & 507. This could position the robot arm at the right position and tilt in space. Over time this could affect the marking loop and add a layer of machine motion to the mark.

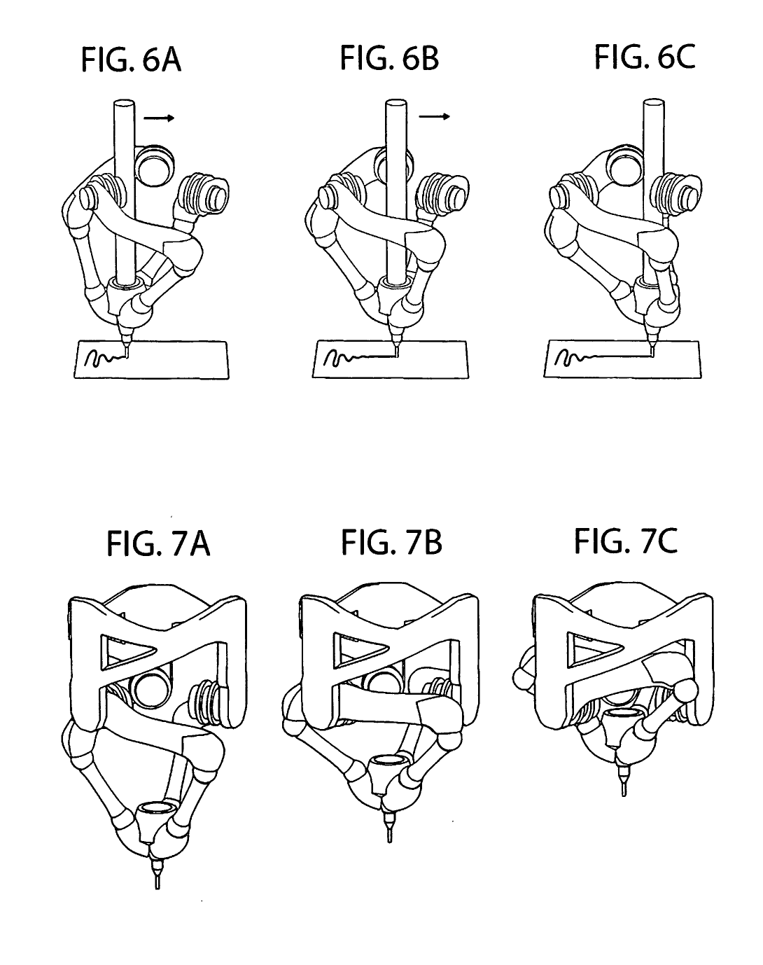

FIG. 6 is a descriptive illustration of machine motion moving the marking region along a surface to create a mark. As the top of the sub-arms change rotation from FIG. 6A to FIG. 6C the marking region moves position. This position change over time creates a mark along the surface.

FIG. 7 is a descriptive illustration of machine motion moving perpendicular to the marking surface. The motion shown from FIGS. 7A to 7C is a type of motion that will pull the pen away from the surface. Such motion allows the robot arm to stop drawing one mark, lift the marking region up, move to a new position, and lower the marking region onto the surface to start creating a new mark. The marking head is moved upward to towards the device frame. In this embodiment the frame has an angled recess so the marking head can pull upward into the body of the frame as shown in FIG. 7C.

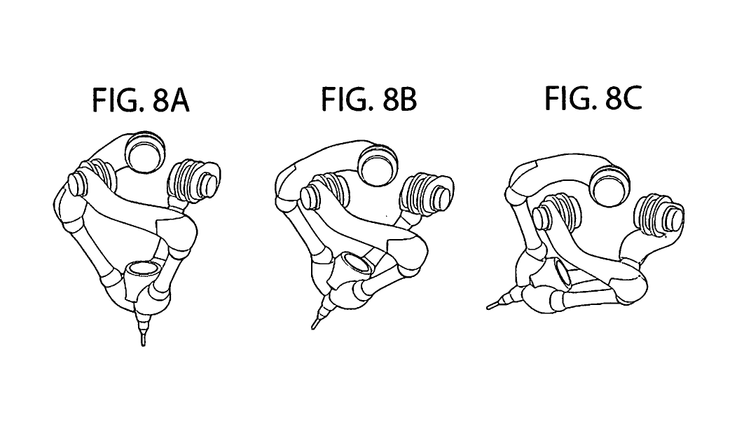

FIG. 8 is a descriptive illustration of machine motion moving from a tilted position to a neutral position where the marking head is parallel the device casing. The motion shown from FIGS. 8A to 8C is a type of motion that pulls the pen away from the neutral position at an angled position. Such a motion is useful for changing the character of marks with a wide region such as marks made by a spray nozzle or brush. In addition, tilt allows the user to hold the device at an angle to the surface and have the device adapt.

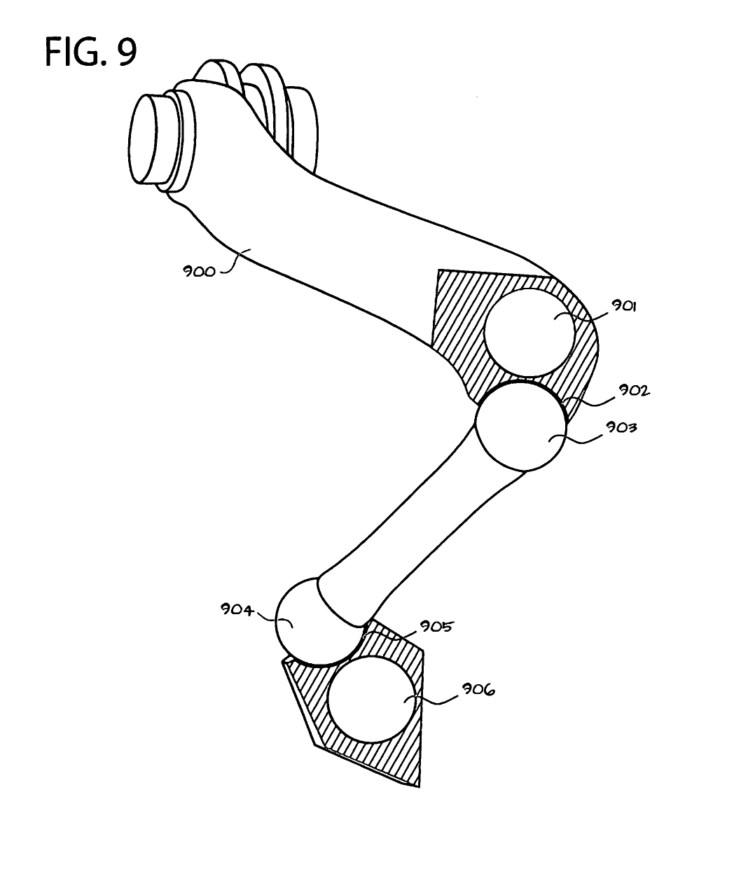

FIG. 9 shows an embodiment of how a sub-arm from FIG. 2 could be constructed with magnetic connections. The top segment 900 of the sub-arm rotates as controlled by the mechanism described in FIG. 3. The end of the segment 900 is the casing for a ball and socket joint. In this embodiment, the sub-arm is constructed with two magnetic ball and socket joints. Each joint consists of two magnets. For example, the ball and socket joint holds a magnet 903 within a cup-like depression 902. Magnet 901 attracts magnet 903 and holds it into place, while the cup-like depression 902 allows the magnet 903 to rotate around a single point. Because the segments are not rigidly connected, they are free to spin and automatically remove extra twisting rotations when reaching Cartesian goals. The joint consisting of magnets 904 and 906 with cup-like depression 905 is connected in a similar way as described above.

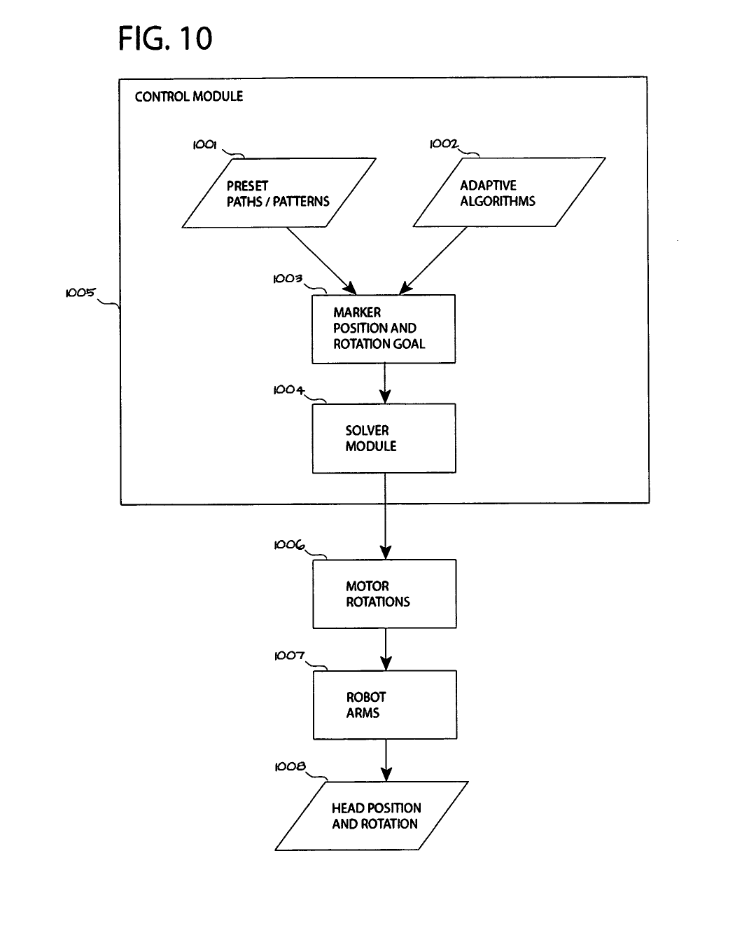

FIG. 10 is a flow chart describing a process for taking input and creating a desired machine motion. In this embodiment, information determining the motion of the marking region can be of various types including preset paths or patterns 1001 or adaptive algorithms 1002. These determine marking region position and rotation goals 1003. With these goals as input, a solver module 1004 determines the corresponding motor rotations 1006 that arrive at that result. Components 1001, 1002, 1003, and 1004 form the control module 1005, which is a combination of hardware and software that determines the final machine motion. The control module could take various forms. These include a form that may be contained in the device, partially contained in the device, or controlled remotely. For example in one embodiment, the control module is on the device, but a remote system, such as a mobile phone or tablet, transmits control code and commands to the device through wireless means. The control module then drives the motor rotations 1006 which move the robot arms 1007 into the configuration that physically places the marking region at the desired position and rotation goal 1008.

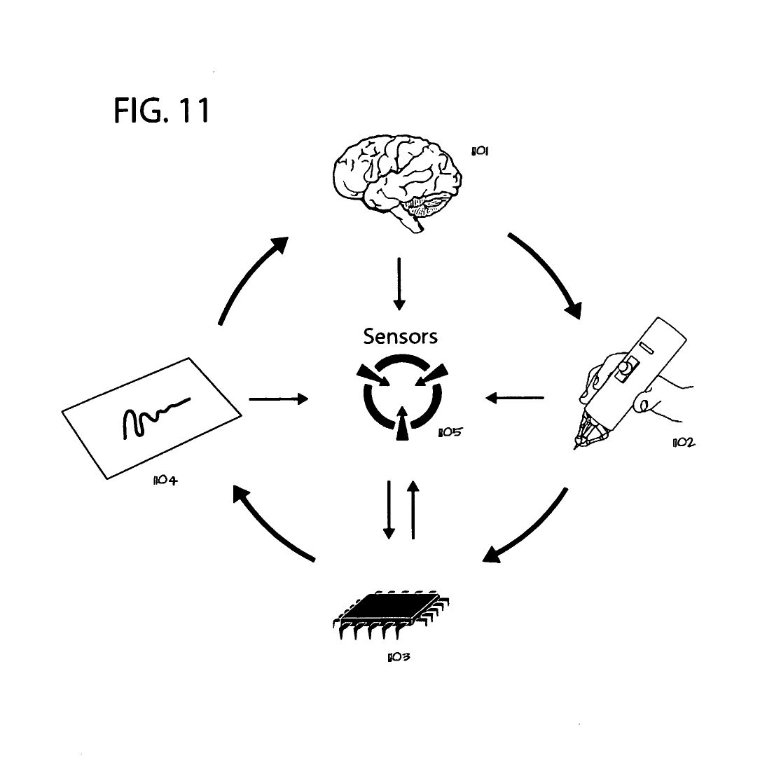

FIG. 11 shows a diagram of the marking loop with machine motion and sensor feedback. The brain 1101 moves the hand 1102, which is in this case, is holding an embodiment of the invention with a robot arm. An electronic control system 1103, in this case a chip drives the motion of motors and results in machine motion. The combined motion of the hand and machine creates the mark 1104. The brain observes the mark and the feedback loop cycles forward. Sensors 1005 can exist at each stage of the marking loop. Changes in the brain activity 1001 can be sensed and used as algorithmic input. For example, line drawn on a surface can be made to squiggle in response to a certain thought. Hand motions 1002 can be sensed, in one embodiment, as tilt and acceleration that allow for numerous adaptive algorithms including: kinematics, dynamics, stabilization, effects, tilt, perspective, and lighting and shading changes. Sensory input can also be from the control system 1103 which can connect to the vast array of information from sources such as the internet, mobile devices, etc. Types of input information could include: location, music, distance from objects, vision system, etc. The device can also receive sensory input from the marking surface and the mark itself through a sensor, such as a camera. The device can dynamically adapt and modify the mark path or pattern based on the exact reality of what is occurring on the surface.

Although the invention has been described in the foregoing embodiments, it is understood that the present disclosure has been made only by way of example, and that numerous changes in the details of implementation of the invention can be made without departing from the spirit and scope of the invention. Features of the disclosed embodiments can be combined and rearranged in various ways.

1. A handheld device that makes marks from the combined motion (including motionless and holding states), position and tilt of:
a hand holding the device
a motor driven mechanical system
The mark created by the device is an area on a surface having different physical properties from its surrounding areas.
The device is comprised of:
1 or more motors that can accurately drive a mechanical system to manipulate a region of mark making:
to an exact position and orientation in space.
to generate marks on a surface over time
to change or maintain velocity and acceleration
an electronic control system or program that manipulates the motion of the motor(s) and the resulting region of mark making over time and space

2. A device according to claim 1 wherein a library of preset marks, shapes and patterns is stored and can be selected and used to drive mechanical motion.

3. A device according to claim 1 wherein the device or part of the device is lifted from a surface then lowered down in a new location to start a new mark.

4. A device according to claim 1 wherein an image source is processed and used to drive the mechanical motion.

5. A device according to claim 1 that is driven by a process that uses algorithms to convert images into vectors.

6. A device according to claim 1 where the marking path changes speed. Speed changes could be: stored within drawing presets, user defined or based on adaptive algorithms.

7. A device according to claim 1 wherein electronics and/or software take digital drawings as input and convert these to one or more motion drawing paths. This motion drawing path could be filtered to control motor acceleration and deceleration based on change of angles within the motion drawing path. Additional filtering could include adaptive sampling of the drawing to generate more motion path samples in areas of complex detail where the motion path angle changes with greater frequency vs. areas of low complexity where angle rates of change are smaller.

8. A device according to claim 1 wherein the user is able to pause and unpause the marking motion using a button on the device.

9. A device according to claim 1 wherein the user is able to dynamically modify the marking path (for example, geometric transformations, such: as scale, rotation, 3d camera angle, perspective, noise, etc.), using an interface (i.e., slider, button, touchscreen, tilt, speed, etc.)

10. A device according to claim 1 wherein the user is able to render a 2d shape, pattern or drawing using a 3d representation as a source.

11. A device according to claim 1 wherein electronics and/or software creates a complete drawing, the image source for the drawing coming via a digital input such as the internet or digital camera.

12. A device according to claim 1 that includes a robot arm. Such an arm could be a two-dimensional robotic components, articulated robots, SCARA robots, Delta robots and Cartesian coordinate robots.

13. A device according to claim 1 with an end nozzle that holds an object such as an ball-point pen, pencil, rolling ball, fountain pen, felt-tip marker, stylus, gouger, paint brush, crayon or other marking device which is used to generate the mark on the surface.

14. A device according to claim 1 with an end nozzle that can be disconnected and re-attached with a different end nozzle.

15. A device according to claim 1 that generates markings that may include: lines, shapes, drawings, patterns, images, handwriting, text, font rendering, etc.

16. A device according to claim 1 wherein electronics and/or software changes the attributes of the line such as: width, pressure, translucency, color, edge feathering, cap, cornering, stroke alignment, dashed lines, arrowheads, etc.

17. A device according to claim 1 wherein electronics and/or software changes the result to include, integrate or geometrically deform into a drawing context: patterns and/or shapes

18. A device according to claim 1 wherein electronics and/or software changes the size of the marking path/pattern

19. A device according to claim 1 wherein electronics and/or software blends or modifies colors to change attributes of the mark, marking path, pattern, image or resulting drawing.

20. A device according to claim 1 wherein electronics and/or software changes the text or style of the mark based on a font/style library.

21. A device according to claim 1 wherein electronics and/or software progressively refines the mark each time it is drawn, for example making a drawing of a head more realistic each marking loop until the user moves the device.

22. A device according to claim 1 that adjusts the device to respond to tilt.

23. A device according to claim 1 wherein electronics and/or software changes the nature of the mark and/or attributes of the mark in response to sensor feedback

24. A device according to claim 1 with motion strategies capable of incorporating feedback signals

25. A device according to claim 1 with motion subject to constraints, arising from kinematics, dynamics, and nonholonomic systems

26. A device according to claim 1 with pre-programmed knowledge of many configurations, and pick one most suitable to its current task.

27. A device according to claim 1 that reacts to dynamic environments

28. A device according to claim 1 wherein electronics and/or software responds to the nature of the primary motion to create effects

29. A device according to claim 1 wherein electronics and/or software performs stabilization

30. A device according to claim 1 wherein electronics and/or software simulates dynamic systems in real time. This could include examples such as: spring, bounce, gravity, physical constraints, collision, etc.

31. A device according to claim 1 wherein electronics and/or software does dynamic lighting and shading changes

32. A device according to claim 1 wherein electronics and/or software auto-completes actions (ex. closing lines)

33. A device according to claim 1 wherein electronics and/or software adapts to the current nature of the drawing the user is making

34. A device according to claim 1 wherein electronics and/or software dynamically adjusts the drawing selection of attributes, shapes, presets, patterns, etc., based on tilt.

35. A device according to claim 1 wherein electronics and/or software dynamically adjusts the drawing selection of attributes, shapes, presets, patterns, etc., based on acceleration.

36. A device according to claim 1 wherein the mark and/or mark attributes are changed by input from a EEG or other signal from the brain

37. A device according to claim 1 where an external digital device such as a phone, tablet or computer acts as input for the creation of mechanical motion

38. A device according to claim 1 where an external digital device such as a phone, tablet, or computer acts as a digital display device to preview the final device motion.

39. A device according to claim 1 wherein electronics and/or software works with a secondary digital device such as a phone or digital tablet functions as a paint application, where the user creates one or more drawings and uploads information to the handheld marking device.

40. A device according to claim 1 wherein electronics and/or software works with a secondary digital device such as a phone or digital tablet functions where the digital device functions as a palette display device for the drawings used by the pen. The user can add, delete or reorder the drawing on this digital device and send those updated changes back to the pen.

41. A device according to claim 1 wherein electronics and/or software works with a camera mounted on the device which records and analyzes the resulting mark. This analysis of the resulting mark is then used to modify the marking path.

42. A device according to claim 1 wherein electronics and/or software works with a camera mounted on the device which records and analyzes a regenerated image below the device. This analysis is then used to modify the marking path.

43. A device according to claim 1 wherein electronics and/or software communicates with the Internet to receive motion drawing paths.

44. A device according to claim 1 wherein electronics and/or software is able to network connect to other pen drawing devices to allow for exchange of digital data, such as drawing presets or styles.

45. A device according to claim 1 wherein electronics and/or software is able to network connect to other pen drawing devices to allow for modification of their marking path.

46. A device according to claim 1 wherein electronics and/or software responds to sound, music, RSS, any internet or any electronic feed.

47. A device according to claim 1 wherein electronics and/or software is controlled with user modifiable programming language.

48. A device according to claim 1 wherein electronics and/or software has programmatic control over aspects of the resulting mark. These may include: shape, printing, line attributes and color.

49. A device according to claim 1 wherein electronics and/or software works with an image database, which can take various digital inputs such as text that is user generated, directly from the internet or from digital documents and convert it to a motion path for the device of the text in a variety of text styles.

50. A device according to claim 1 wherein electronics and/or software generates motion paths for mark making based on user defined marks as well as parametric marks. One such example of a parametric mark could be a number symbol, the number symbol would generate a dynamically changing mark such as increasing the number by a step of 1 after the completion of each mark. This parametric mark could also involve words, shapes and patterns.
